(19) United States
(12) Patent Application Publication
(10) Pub. No.: US 2016/0071667 A1
(43) Pub. Date: Mar. 10, 2016

(54) CLICK MECHANISM AND INPUT DEVICE

(71) Applicant: ALPS ELECTRIC CO., LTD., Tokyo (JP)

(72) Inventors: Kazunari Takahashi, Miyagi-ken (JP); Rei Namiki, Miyagi-ken (JP); Ken Kosaka, Miyagi-ken (JP)

(21) Appl. No.: 14/848,776

(22) Filed: Sep. 9, 2015

(30) Foreign Application Priority Data
Sep. 10, 2014 (JP) 2014-184205

(51) Int. Cl. H01H 19/14; H01F 7/02

(52) U.S. Cl. CPC H01H 19/14; H01F 7/0273

(57) ABSTRACT

A click mechanism includes a first magnetic body having a first protrusion, a second magnetic body having a second protrusion, and a magnet configured to magnetize at least one of the first magnetic body and the second magnetic body. The click mechanism is configured to, in accordance with input operation, move at least one of the first magnetic body and the second magnetic body relative to the other, and generate click sensation corresponding to the input operation using magnetic attractive force generated between the first protrusion and the second protrusion. The second magnetic body further has a third protrusion configured to generate magnetic attractive force between itself and the first protrusion and differing in shape from the second protrusion.

### CLAIM OF PRIORITY

This application claims benefit of priority to Japanese Patent Application No. 2014-184205 filed on Sep. 10, 2014, which is hereby incorporated by reference in its entirety.

### BACKGROUND

1. Field of the Disclosure

The present disclosure relates to a click mechanism and an input device, and more specifically, it relates to a click mechanism suitable for a non-contact input device, and an input device having it.

2. Description of the Related Art

In recent years, a non-contact input device that has a detecting magnet moving in accordance with input operation and a magnetic sensor detecting the strength of magnetic field experienced from the detecting magnet and that detects input operation to an operation member in a′non-contact manner on the basis of the strength of magnetic field detected by the magnetic sensor has come into practical use as a stalk switch for activating a direction indicator of a vehicle and an input device such as a rotary encoder for an electronic device.

It is preferable for a click mechanism used in such a non-contact input device not to generate click sensation utilizing contact and separation of a moving contact and a fixed contact as in conventional switch devices but to generate click sensation in a non-contact manner as with the detection of input operation.

A technique relating to a click mechanism compatible with such a non-contact input device is disclosed, for example, in Japanese Unexamined Patent Application Publication No. 2003-280799. The configuration of a conventional click mechanism will be described with reference to FIGS. 10A to 10D below. FIGS. 10A to 10D are explanatory diagrams showing the configuration of a conventional click mechanism, and show the configuration of a click mechanism part of an information input device 111 according to Japanese Unexamined Patent Application Publication No. 2003-280799.

As shown in FIGS. 10A to 10D, the information input device 111 includes a click sensation generating magnetic body 142 and a rotation detecting magnetic body 152. The click sensation generating magnetic body 142 is held so as to rotate together with a rotating body (operation member) (not shown) of the information input device 111. The click sensation generating magnetic body 142 has a plurality of magnetic poles that are magnetized such that the directions of lines of magnetic force thereof are opposite to each other and that are disposed alternately at regular angular intervals along the circumference of a circle centered at the center of rotation of the rotating body. The rotation detecting magnetic body 152 is fixed to a holding member (not shown) of the information input device 111 so as to be opposed to the click sensation generating magnetic body 142 with a predetermined spacing therebetween. The rotation detecting magnetic body 152 also has a plurality of magnetic poles that are magnetized such that the directions of lines of magnetic force thereof are opposite to each other and that are disposed alternately at regular angular intervals along the circumference of a circle centered at the center of rotation of the rotating body.

In the information input device 111, the click sensation generating magnetic body 142 and the rotation detecting magnetic body 152 have such configurations, and magnetic action (magnetic attractive force or magnetic repulsive force) is thereby generated between the magnetic poles of the click sensation generating magnetic body 142 and the magnetic poles of the rotation detecting magnetic body 152. Utilizing the magnetic action between the magnetic poles of the click sensation generating magnetic body 142 and the magnetic poles of the rotation detecting magnetic body 152, click sensation accompanying the rotation of the rotating body is generated in a non-contact manner.

In the conventional click mechanism according to Japanese Unexamined Patent Application Publication No. 2003-280799, the magnetic poles of the click sensation generating magnetic body 142 are disposed at regular angular intervals, and the magnetic poles of the rotation detecting magnetic body 152 are also disposed at regular angular intervals. Therefore, the click sensation generated utilizing the magnetic action between the magnetic poles of the click sensation generating magnetic body 142 and the magnetic poles of the rotation detecting magnetic body 152 is such monotonous click sensation that the same click sensation is repeatedly generated with the rotation of the rotating body.

On the other hand, input devices are desired to generate various operation sensations in accordance with the operation of the operator in order to improve the operability. In the conventional click mechanism according to Japanese Unexamined Patent Application Publication No. 2003-280799, only monotonous click sensation can be generated, and generating various operation sensations is difficult.

### SUMMARY

A click mechanism includes a first magnetic body having a first protrusion, a second magnetic body having a second protrusion, and a magnet configured to magnetize at least one of the first magnetic body and the second magnetic body. The click mechanism is configured to, in accordance with input operation, move at least one of the first magnetic body and the second magnetic body relative to the other, and generate click sensation corresponding to the input operation using magnetic attractive force generated between the first protrusion and the second protrusion. The second magnetic body further has a third protrusion configured to generate magnetic attractive force between itself and the first protrusion and differing in shape from the second protrusion.

In the click mechanism having this configuration, two magnetic attractive forces of different magnitudes acting on the first protrusion can be generated by the second protrusion and the third protrusion that differ in shape from each other. By combining the two magnetic attractive forces of different magnitudes, the magnetic attractive force acting on the first protrusion can be changed complexly in accordance with the change of relative position of the first magnetic body and the second magnetic body, and variety can be thereby given to click sensation. As a result, various operation sensations can be generated in accordance with input operation.

### BRIEF DESCRIPTION OF THE DRAWINGS

FIG. 1 is a perspective view showing an input device according to the embodiment of the present invention;

FIG. 2 is a perspective view showing an operation member and a click mechanism according to the embodiment of the present invention;

FIG. 3 is a perspective view showing a click sensation generating portion according to the embodiment of the present invention;

FIG. 4 is an exploded perspective view showing the configuration of the click sensation generating portion according to the embodiment of the present invention;

FIGS. 5A and 5B are explanatory diagrams showing the arrangement of first protrusions, second protrusions, and third protrusions according to the embodiment of the present invention;

FIGS. 6A and 6B are explanatory diagrams showing the cross-section structure of a magnetizing member and a rotating body according to the embodiment of the present invention;

FIGS. 7A to 7C are first explanatory diagrams showing the direction of magnetic attractive force in the embodiment of the present invention;

FIGS. 8A to 8C are second explanatory diagrams showing the direction of magnetic attractive force in the embodiment of the present invention;

FIG. 9 is an explanatory diagram relating to the operation sensation according to the embodiment of the present invention; and

FIGS. 10A to 10D are explanatory diagrams showing the configuration of a conventional click mechanism.

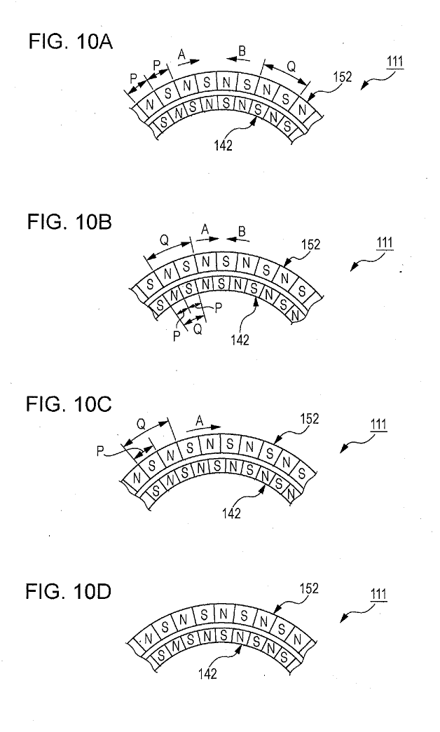

### DESCRIPTION OF THE EXEMPLARY EMBODIMENTS

The embodiment of the present invention will now be described with reference to the drawings. In each figure, arrow X1 represents a leftward direction, arrow X2 represents a rightward direction, arrow Y1 represents a forward direction arrow Y2 represents a backward direction, arrow Z1 represents an upward direction, and arrow Z2 represents a downward direction.

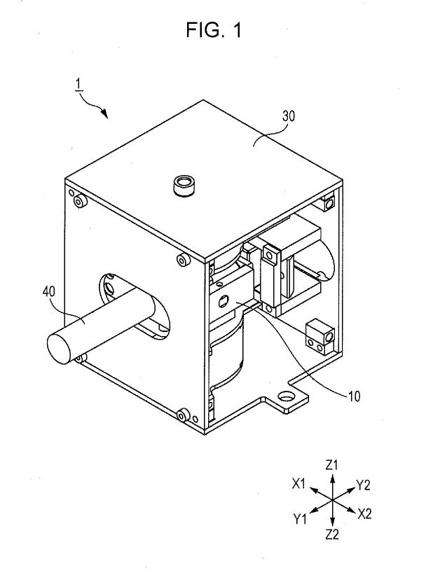

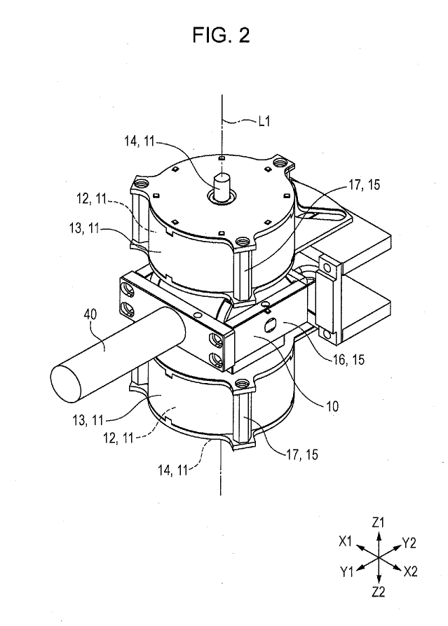

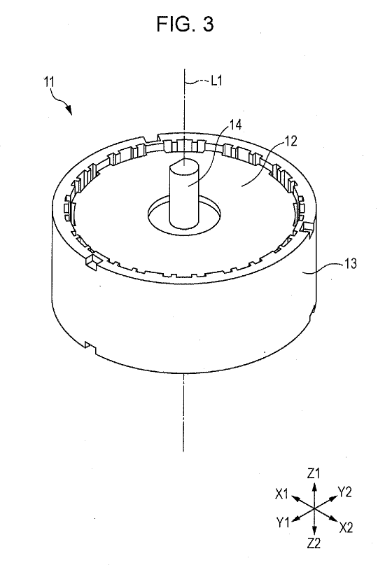

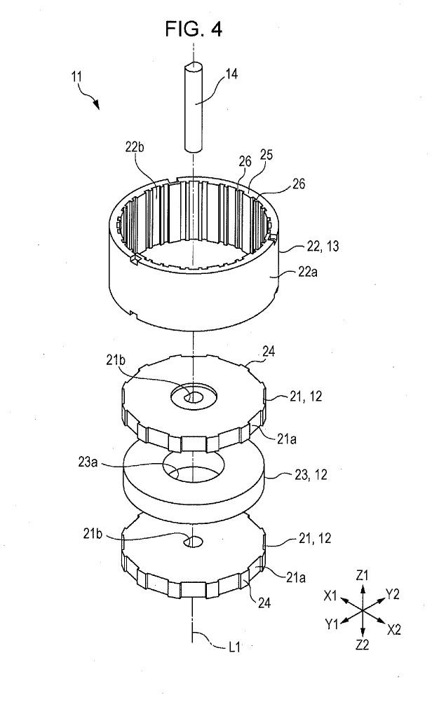

First, the configurations of a click mechanism and an input device according to the embodiment of the present invention will be described with reference to FIG. 1 to FIG. 6B. FIG. 1 is a perspective view showing an input device according to the embodiment of the present invention. FIG. 2 is a perspective view showing an operation member and a click mechanism according to the embodiment of the present invention. FIG. 3 is a perspective view showing a click sensation generating portion according to the embodiment of the present invention. FIG. 4 is an exploded perspective view showing the configuration of the click sensation generating portion according to the embodiment of the present invention.

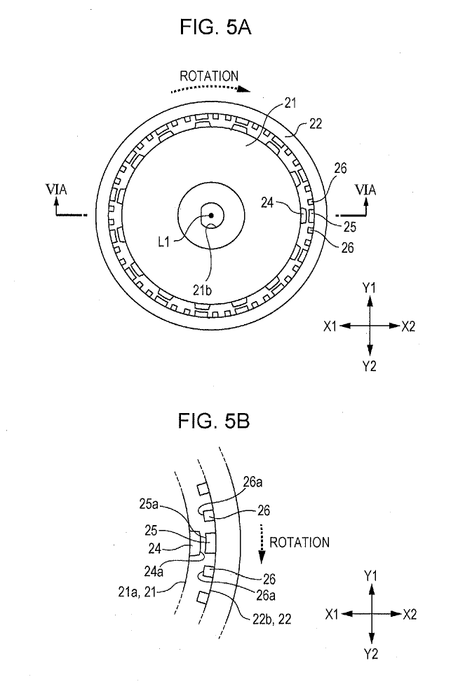

FIGS. 5A and 5B are explanatory diagrams showing the arrangement of first protrusions, second protrusions, and third protrusions according to the embodiment of the present invention. FIG. 5A shows the arrangement of first protrusions 24, second protrusions 25, and third protrusions 26 when a first magnetic body 21 and a second magnetic body 22 are viewed from above. FIG. 5B shows an enlarged view of the first protrusion 24 near the right end of the first magnetic body 21 shown in FIG. 5A, and the second protrusion 25 and the third protrusions 26 near the left end of the second magnetic body 22.

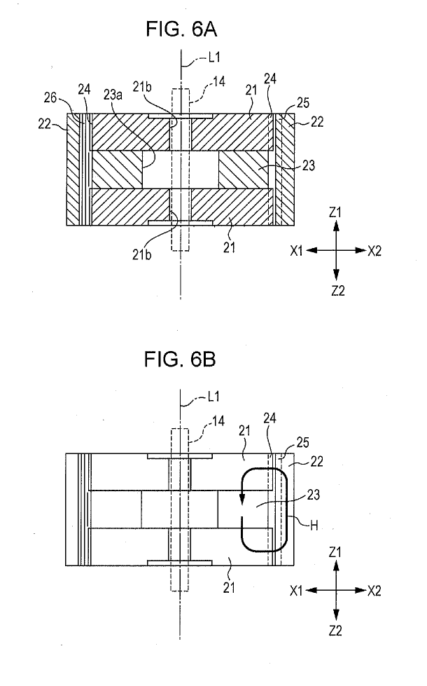

FIGS. 6A and 6B are explanatory diagrams showing the cross-section structure of a magnetizing member and a rotating body according to the embodiment of the present invention. FIG. 6A schematically shows the cross-section structure of a magnetizing member 12 and a rotating body 13 corresponding to a section taken along line VIA-VIA of FIG. 5A. FIG. 6B schematically shows the direction of a magnetic path formed at a position corresponding to FIG. 6A by the first magnetic body 21, the second magnetic body 22, and a magnet 23.

The input device 1 according to the embodiment of the present invention is a non-contact input device that detects input operation to an operation member in a non-contact manner on the basis of the strength of magnetic field experienced from a detecting magnet that moves with the movement of the operation member, and is used, for example, in a stalk switch for activating a direction indicator of a vehicle.

The input device 1 has a click mechanism 10, a case member 30, an operation portion 40, and an input detecting portion (not shown) as shown in FIG. 1. The click mechanism 10 has two click sensation generating portions 11 and a driving portion 15 as shown in FIG. 2. The two click sensation generating portions 11 are disposed, one on each of the top and bottom of the driving portion 15.

Each click sensation generating portion 11 has a magnetizing member 12, a rotating body 13, and a shaft member 14 as shown in FIG. 2 and FIG. 3. The magnetizing member 12 has two first magnetic bodies 21 and a magnet 23 as shown in FIG. 4. Each first magnetic body 21 has a plurality of first protrusions 24 formed thereon as shown in FIG. 4 to FIG. 6B. In this embodiment, the rotating body 13 corresponds to a second magnetic body 22. The second magnetic body 22 has a plurality of second protrusions 25 and a plurality of third protrusions 26 formed thereon as shown in FIG. 4 to FIG. 6B.

Each first magnetic body 21 is made of a metal that is a soft magnetic body. As shown in FIG. 4, each first magnetic body 21 is a cylindrical member centered at an imaginary line L1 extending in the vertical direction, and has an outer peripheral surface 21a. Each first magnetic body 21 has a vertical through-hole 21b formed therein along the imaginary line L1.

The magnet 23 is a magnet made by magnetizing a metal such as iron. As shown in FIG. 4, the magnet 23 is a cylindrical member coaxial with each first magnetic body 21, and the outside diameter (the diameter of the cylindrical part) of the magnet 23 is about the same as the outside diameter (the diameter of the cylindrical part) of each first magnetic body 21. The magnet 23 has a vertical through-hole 23a formed therein along the imaginary line L1. The magnet 23 is magnetized such that the upper end side thereof and the lower end side thereof differ in magnetic polarity.

The two first magnetic bodies 21 are stacked so as to vertically sandwich the magnet 23 and form the magnetizing member 12. The first magnetic body 21 on the upper side of the magnet 23 and the first magnetic body 21 on the lower side of the magnet 23 are magnetized by the magnet 23 so as to differ from each other in magnetic polarity. A shaft member 14 is attached to the magnetizing member 12 so as to vertically pass through the through-holes 21b of the first magnetic bodies 21 and the through-hole 23a of the magnet 23.

The second magnetic body 22 is made of a metal that is a soft magnetic body. As shown in. FIG. 4, the second magnetic body 22 is a hollow cylindrical member coaxial with the first magnetic bodies 21, and has an outer peripheral surface 22a and an inner peripheral surface 22b. The inside diameter (the diameter of the inner peripheral surface 22b side of the hollow cylindrical part) of the second magnetic body 22 is larger than the outside diameter of the first magnetic bodies 21, and the vertical thickness of the second magnetic body 22 is about the same as the vertical thickness of the magnetizing member 12.

The second magnetic body 22 houses the magnetizing member 12 in a space surrounded by the inner peripheral surface 22b, and is held by the shaft member 14 rotatably about the shaft center of the shaft member 14. The second magnetic body 22 rotationally moves relative to the first magnetic bodies 21 and the magnet 23. “The second magnetic body 22 rotationally moves relative to the first magnetic bodies 21” will be hereinafter simply referred to as “the second magnetic body 22 rotates.” The method for holding the second magnetic body 22 rotatably is known, so the detailed description thereof will be omitted.

The plurality of first protrusions 24 are formed on the outer peripheral surface 21a of each first magnetic body 21 as shown in FIG. 4 to FIG. 6B. The first protrusions 24 are disposed at regular intervals along the direction of rotation of the second magnetic body 22, at a plurality of locations on the outer peripheral surface 21a of each first magnetic body 21. The plurality of second protrusions 25 and the plurality of third protrusions 26 are formed on the inner peripheral surface 22b of the second magnetic body 22 as shown in FIG. 4 to FIG. 6B. The second protrusions 25 are the same in number as the first protrusions 24, and are disposed at regular intervals along the direction of rotation of the second magnetic body 22. The third protrusions 26 are disposed along the direction of rotation of the second magnetic body 22, one on each side of each second protrusion 25, so as to be adjacent to each second protrusion 25.

The second protrusions 25 and the third protrusions 26 are disposed so as to be capable of being opposed to the first protrusions 24 with a clearance therebetween. The wording “disposed so as to be capable of being opposed to the first protrusions 24 with a clearance therebetween” means that the protrusions are disposed so as to be opposed to the first protrusions 24 with a predetermined opposed spacing therebetween when moved to opposed positions to the first protrusions 24 with the rotation of the second magnetic body 22.

In this embodiment, the first protrusions 24 are substantially rectangular parallelepiped protrusions that protrude from the outer peripheral surface 21a of each first magnetic body 21 in an outer peripheral direction (a direction away from the imaginary line L1 that is the central axis) and that extend vertically from the upper end to the lower end of each first magnetic body 21, and have substantially rectangular opposed surfaces 24a that are opposed to the second protrusions 25 and the third protrusions 26. The second protrusions 25 are substantially rectangular parallelepiped protrusions that protrude from the inner peripheral surface 22b of the second magnetic body 22 in a central axis direction (a direction toward the imaginary line L1 that is the central axis) and that extend vertically from the upper end to the lower end of the second magnetic body 22, and have substantially rectangular opposed surfaces 25a that are opposed to the first protrusions 24. The third protrusions 26 are substantially rectangular parallelepiped protrusions that protrude from the inner peripheral surface 22b of the second magnetic body 22 in the central axis direction and that extend vertically from the upper end to the lower end of the second magnetic body 22, and have substantially rectangular opposed surfaces 26a that are opposite to the first protrusions 24.

In the following description, the width of the opposed surfaces 24a of the first protrusions 24 along the direction of rotation of the second magnetic body 22 will be referred to as the width of the first protrusions 24, and the vertical thickness of the first protrusions 24 will be referred to as the thickness of the first protrusions 24. In the following description, the width of the opposed surfaces 25a of the second protrusions 25 along the direction of rotation of the second magnetic body 22 will be referred to as the width of the second protrusions 25, and the vertical thickness of the second protrusions 25 will be referred to as the thickness of the second protrusions 25. In the following description, the width of the opposed surfaces 26a of the third protrusions 26 along the direction of rotation of the second magnetic body 22 will be referred to as the width of the third protrusions 26, and the vertical thickness of the third protrusions 26 will be referred to as the thickness of the third protrusions 26.

The opposed area of the first protrusions 24 and the second protrusions 25 when the first protrusions 24 and the second protrusions 25 are directly opposed to each other (when the second protrusions 25 are moved in front of the first protrusions 24 with the rotation of the second magnetic body 22) will be simply referred to as the opposed area of the first protrusions 24 and the second protrusions 25, and the opposed spacing of the first protrusions 24 and the second protrusions 25 when the first protrusions 24 and the second protrusions 25 are directly opposed to each other will be simply referred to as the opposed spacing of the first protrusions 24 and the second protrusions 25. The opposed area of the first protrusions 24 and the third protrusions 26 when the first protrusions 24 and the third protrusions 26 are directly opposed to each other (when the third protrusions 26 are moved in front of the first protrusions 24 with the rotation of the second magnetic body 22) will be simply referred to as the opposed area of the first protrusions 24 and the third protrusions 26, and the opposed spacing of the first protrusions 24 and the third protrusions 26 when the first protrusions 24 and the third protrusions 26 are directly opposed to each other will be simply referred to as the opposed spacing of the first protrusions 24 and the third protrusions 26.

In this embodiment, the first protrusions 24 are formed such that the thickness of the first protrusions 24 is about the same as the vertical thickness of the first magnetic bodies 21. The second protrusions 25 are formed such that the width of the second protrusions 25 is slightly smaller than the width of the first protrusions 24 and the thickness of the second protrusions 25 is about the same as the vertical thickness of the second magnetic body 22. The third protrusions 26 are formed such that the width of the third protrusions 26 is smaller than the width of the second protrusions 25 and the thickness of the third protrusions 26 is the same as the thickness of the second protrusions 25. The first protrusions 24, the second protrusions 25, and the third protrusions 26 are formed such that the opposed spacing of the first protrusions 24 and the second protrusions 25 is about the same as the opposed spacing of the first protrusions 24 and the third protrusions 26.

The driving portion 15 has a turning portion 16 and connecting portions 17. The operation portion 40 of the input device 1 is attached to the turning portion 16, and the turning portion 16 turns in conjunction with the operation portion 40 about the imaginary line L1. The connecting portions 17 connect the turning portion 16 and the second magnetic bodies 22, and turns the second magnetic bodies 22 in conjunction with the turning of the turning portion 16. The click mechanism 10 has such a configuration.

The case member 30 houses the click mechanism 10. One end of each shaft member 14 of the click mechanism 10 is fixed to the case member 30 by screwing or the like. By fixing the end of each shaft member 14 to the case member 30, the magnetizing members 12 are fixed to the case member 30, and the second magnetic bodies 22 are held rotatably relative to the magnetizing members 12.

The operation portion 40 is exposed on the outside of the case member 30 and receives input operation from the operator. The operation portion 40 turns about the imaginary line L1 together with the turning portion 16 of the driving portion 15 of the click mechanism 10 in accordance with the input operation from the operator.

The configuration and detection principle of the aforementioned input detecting portion are known, so the detailed description thereof will be omitted. The input detecting portion has a detecting magnet (not shown) moving in accordance with input operation and a magnetic sensor (not shown) detecting the strength of magnetic field experienced from the detecting magnet, and detects input operation in a non-contact manner on the basis of the strength of magnetic field detected by the magnetic sensor. The input device 1 has such a configuration.

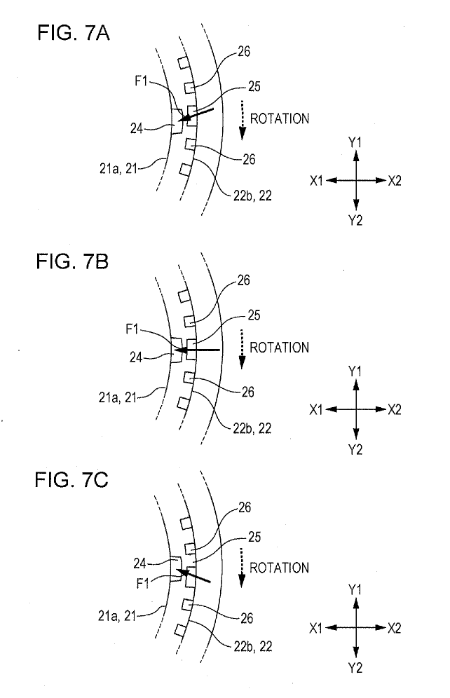

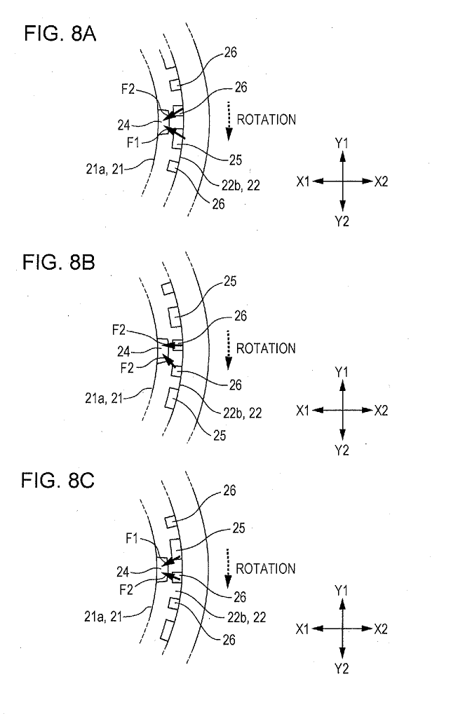

Next, the working and operation sensation at the time of input operation of the click mechanism 10 will be described with reference to FIG. 7A to FIG. 9. FIGS. 7A to 7C are first explanatory diagrams showing the direction of magnetic attractive force in the embodiment of the present invention. FIGS. 8A to 8C are second explanatory diagrams showing the direction of magnetic attractive force in the embodiment of the present invention. FIGS. 7A to 7C and FIGS. 8A to 8C schematically show the direction of magnetic attractive force F1 and the direction of magnetic attractive force F2 corresponding to the rotational position of the second magnetic body 22 when the second magnetic body 22 rotates clockwise relative to the first magnetic bodies 21.

FIG. 7A shows the direction of magnetic attractive force when the second protrusion 25 is located at a position slightly shifted counterclockwise from the directly opposed position to the first protrusion 24. FIG. 7B shows the direction of magnetic attractive force when the second magnetic body 22 is rotated clockwise slightly and the second protrusion 25 is brought to the directly opposed position to the first protrusion 24. FIG. 7C shows the direction of magnetic attractive force when the second magnetic body 22 is rotated clockwise further and the second protrusion 25 is brought to a position slightly shifted clockwise from the directly opposed position to the first protrusion 24. FIG. 8A shows the direction of magnetic attractive force when the second magnetic body 22 is rotated clockwise further from the position shown in FIG. 7C. FIG. 8B shows the direction of magnetic attractive force when the second magnetic body 22 is rotated clockwise further from the position shown in FIG. 8A. FIG. 8C shows the direction of magnetic attractive force when the second magnetic body 22 is rotated clockwise further from the position shown in FIG. 8B.

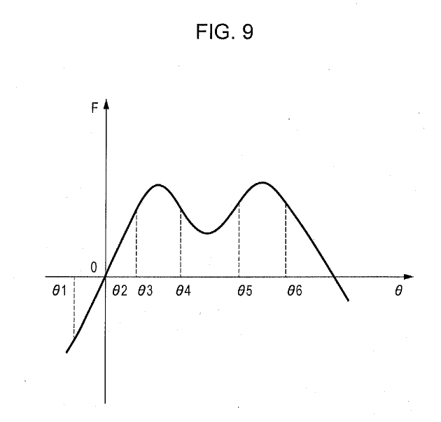

FIG. 9 is an explanatory diagram relating to the operation sensation according to the embodiment of the present invention. FIG. 9 schematically shows the change of force F required for the rotation of the second magnetic body 22 with respect to the rotation angle θ (the amount of rotation) of the second magnetic body 22 with a position where the second protrusion 25 is located at the directly opposed position to the first protrusion 24 as a reference. In FIG. 9, the horizontal axis shows rotation angle θ and the vertical axis shows magnitude of force F. When force F is positive, magnetic attractive force acts so as to suppress the rotation of the second magnetic body 22. When force F is negative, magnetic attractive force acts so as to promote the rotation of the second magnetic body 22.

In FIG. 9, θ1 is the rotation angle of the second magnetic body 22 corresponding to the position shown in FIG. 7A, θ2 is the rotation angle of the second magnetic body 22 corresponding to the position shown in FIG. 7B, θ3 is the rotation angle of the second magnetic body 22 corresponding to the position shown in FIG. 7C, θ4 is the rotation angle of the second magnetic body 22 corresponding to the position shown in FIG. 8A, θ5 is the rotation angle of the second magnetic body 22 corresponding to the position shown in FIG. 8B, and θ6 is the rotation angle of the second magnetic body 22 corresponding to the position shown in FIG. 8C.

First, the working of the click mechanism 10 and the direction of magnetic attractive force accompanying it will be described. As described above, the second magnetic body 22 is held rotatably relative to the first magnetic bodies 21. With the rotation of the second magnetic body 22, the second protrusions 25 and the third protrusions 26 of the second magnetic body 22 rotationally move relative to the first protrusions 24 of the first magnetic bodies 21, and the second protrusions 25 and the third protrusions 26 are thereby moved toward and away from the first protrusions 24.

Since the first magnetic bodies 21 are magnetized by the magnet 23, the second magnetic body 22 is magnetized via the first protrusions 24 and the second protrusions 25 when the second protrusions 25 are close to the first protrusions 24. Then, as shown in FIG. 6B, the two first magnetic bodies 21, the second magnetic body 22, and the magnet 23 form a magnetic path H such that magnetic flux concentrates between the first protrusions 24 and the second protrusions 25. As a result, magnetic attractive force is generated between the first protrusions 24 and the second protrusions 25.

Although not shown, when the third protrusions 26 are close to the first protrusions 24, the two first magnetic bodies 21, the second magnetic body 22, and the magnet 23 form a magnetic path such that magnetic flux concentrates between the first protrusions 24 and the third protrusions 26. As a result, magnetic attractive force is generated between the first protrusions 24 and the third protrusions 26. In the following description, as shown in FIGS. 7A to 7C and FIGS. 8A to 8C, the magnetic attractive force generated between the first protrusions 24 and the second protrusions 25 will be referred to as magnetic attractive force F1, and the magnetic attractive force generated between the first protrusions 24 and the third protrusions 26 will be referred to as magnetic attractive force F2.

In this embodiment, as described above, the third protrusions 26 are formed such that the width of the third protrusions 26 is small compared to the width of the second protrusions 25. The smaller the width or thickness of two opposed magnetic bodies, the smaller the opposed area of the two magnetic bodies. Therefore, the opposed area of the first protrusions 24 and the third protrusions 26 is smaller than the opposed area of the first protrusions 24 and the second protrusions 25. The smaller the opposed area of two opposed magnetic bodies, the smaller the magnetic attractive force generated between the two magnetic bodies. Therefore, the magnitude of magnetic attractive force F2 when the first protrusions 24 and the third protrusions 26 are directly opposed to each other is smaller than the magnitude of magnetic attractive force F1 when the first protrusions 24 and the second protrusions 25 are directly opposed to each other. Since the third protrusions 26 are disposed along the direction of rotation of the second magnetic body 22 so as to be adjacent to the second protrusions 25, magnetic attractive force F1 and magnetic attractive force F2 can exert influence on each other.

Next, the operation sensation accompanying the working of the click mechanism 10 will be described. First, as shown in FIG. 7A, when the second protrusion 25 is located at a position slightly shifted counterclockwise from the directly opposed position to the first protrusion 24, magnetic attractive force F1 acts so as to attract the second protrusion 25 into the directly opposed position to the first protrusion 24. Therefore, as shown in FIG. 9, in the vicinity of rotation angle θ1, force F required for the rotation of the second magnetic body 22 is negative.

Next, as shown in FIG. 7B, when the second magnetic body 22 is rotated clockwise slightly and the second protrusion 25 is brought to the directly opposed position to the first protrusions 24, magnetic attractive force F1 acts along the central axis direction, and magnetic attractive force hardly acts in the direction of rotation of the second magnetic body 22. Therefore, as shown in FIG. 9, force F at rotation angle θ2 is almost zero.

Next, as shown in FIG. 7C, when the second magnetic body 22 is rotated clockwise further and the second protrusion 25 is brought to a position slightly shifted clockwise from the directly opposed position to the first protrusion 24, magnetic attractive force F1 starts to act so as to pull back the second protrusion 25 to the directly opposed position to the first protrusion 24. Therefore, as shown in FIG. 9, in the vicinity of rotation angle θ3, force F gradually increases in accordance with the amount of rotation of the second magnetic body 22.

Next, as shown in FIG. 8A, when the second magnetic body 22 is rotated clockwise further and the second protrusion 25 is brought to a position further shifted from the position shown in FIG. 7C, in accordance with the amount of rotation of the second magnetic body 22, the second protrusion 25 gradually moves away from the first protrusion 24, and magnetic attractive force F1 gradually decreases. On the other hand, in accordance with the amount of rotation of the second magnetic body 22, the third protrusion 26 gradually moves toward the first protrusion 24, and accordingly, magnetic attractive force F2 starts to act so as to attract the third protrusion 26 toward the first protrusion 24. Magnetic attractive force F1 and magnetic attractive force F2 are combined, and the magnetic attractive force acting in a direction opposite to the direction of rotation of the second magnetic body 22 gradually decreases. Therefore, as shown in FIG. 9, in the vicinity of rotation angle θ4, force F gradually decreases in accordance with the amount of rotation of the second magnetic body 22.

Next, as shown in FIG. 8B, when the second magnetic body 22 is rotated clockwise further and the third protrusion 26 is brought to a position further shifted from the position shown in FIG. 8A, the third protrusion 26 gradually moves away from the first protrusion 24, and magnetic attractive force F2 starts to act so as to pull back the third protrusion 26 toward the first protrusion 24. Therefore, as shown in FIG. 9, in the vicinity of rotation angle θ5, force F increases again in accordance with the amount of rotation of the second magnetic body 22.

At the position shown in FIG. 8B, the next third protrusion 26 adjacent to the aforementioned third protrusion 26 is also close to the first protrusion 24, and magnetic attractive force F2 also acts between the next third protrusion 26 and the first protrusion 24. However, since the next third protrusion 26 is almost directly opposed to the first protrusion 24, the magnetic attractive force F2 between the first protrusion 24 and the next third protrusion 26 acts along the central axis direction, and hardly acts in the direction of rotation of the second magnetic body 22.

Next, as shown in FIG. 8C, when the second magnetic body 22 is rotated clockwise further and the next third protrusion 26 is brought to a position further shifted from the position shown in FIG. 8B, the next second protrusion 25 adjacent thereto starts to approach the first protrusion 24, and magnetic attractive force F1 starts to act so as to attract the next second protrusion 25 toward the first protrusion 24. Therefore, as shown in FIG. 9, in the vicinity of rotation angle θ6, force F decreases again in accordance with the amount of rotation of the second magnetic body 22.

In the click mechanism 10 of this embodiment, force F is thus changed in accordance with the amount of rotation of the second magnetic body 22, and click sensation corresponding to the input operation is thereby generated. By generating two magnetic attractive forces of different magnitudes acting on the first protrusion 24 and combining the two magnetic attractive forces of different magnitudes, force F is changed complexly in accordance with the amount of rotation of the second magnetic body 22, and variety is given to click sensation.

Next, the advantageous effects of this embodiment will be described. In the click mechanism 10 of this embodiment, two magnetic attractive forces of different magnitudes acting on the first protrusion 24 can be generated by the second protrusion 25 and the third protrusion 26 that differ in shape from each other. By combining the two magnetic attractive forces of different magnitudes, the magnetic attractive force acting on the first protrusion 24 can be changed complexly in accordance with the amount of rotation of the second magnetic body 22 (the change of relative position of the first magnetic body 21 and the second magnetic body 22), and variety can be thereby given to click sensation. As a result, various operation sensations can be generated in accordance with input operation.

In the click mechanism 10 of this embodiment, by making the magnetic attractive force F2 when the first protrusion 24 and the third protrusion 26 are directly opposed to each other smaller than the magnetic attractive force F1 when the first protrusion 24 and the second protrusion 25 are directly opposed to each other, magnetic attractive force F1 can be made relatively large compared to magnetic attractive force F2, and therefore magnetic attractive force F1 is suitable as magnetic attractive force for generating click sensation. On the other hand, magnetic attractive force F2 can be made relatively small compared to magnetic attractive force F1, and therefore magnetic attractive force F2 is suitable as magnetic attractive force for giving variety to click sensation. By combining such two magnetic attractive forces of different magnitudes, variety can be easily given to click sensation. As a result, various operation sensations can be easily generated in accordance with input operation.

In the click mechanism 10 of this embodiment, the opposed area of the first protrusion 24 and the third protrusion 26 is smaller than the opposed area of the first protrusion 24 and the second protrusion 25. The smaller the opposed area of two opposed magnetic bodies, the smaller the magnetic attractive force generated between the two opposed magnetic bodies. Therefore, by thus forming the second protrusion 25 and the third protrusion 26, the magnetic attractive force F2 when the first protrusion 24 and the third protrusion 26 are directly opposed to each other can be easily made smaller than the magnetic attractive force F1 when the first protrusion 24 and the second protrusion 25 are directly opposed to each other. As a result, various operation sensations can be easily generated in accordance with input operation.

In the click mechanism 10 of this embodiment, the width of the third protrusion 26 is small compared to the width of the second protrusion 25. The smaller the width or thickness of two opposed magnetic bodies, the smaller the opposed area of the two opposed magnetic bodies. Therefore, by thus forming the second protrusion 25 and the third protrusion 26, the opposed area of the first protrusion 24 and the third protrusion 26 can be easily made smaller than the opposed area of the first protrusion 24 and the second protrusion 25. The magnetic attractive force F2 when the first protrusion 24 and the third protrusion 26 are directly opposed to each other can be thereby made smaller than the magnetic attractive force F1 when the first protrusion 24 and the second protrusion 25 are directly opposed to each other. As a result, various operation sensations can be easily generated in accordance with input operation.

In the click mechanism 10 of this embodiment, by making the width of the third protrusion 26 small compared to the width of the second protrusion 25, it is possible not only to change the magnitude of magnetic attractive force F2 relative to the magnitude of magnetic attractive force F1 but also to make the range of rotation angles within which magnetic attractive force F2 acts between the first protrusion 24 and the third protrusion 26 narrower than the range of rotation angles within which magnetic attractive force F1 acts between the first protrusion 24 and the second protrusion 25. By changing the range of rotation angles within which magnetic attractive force F2 acts relative to the range of rotation angles within which magnetic attractive force F1 acts, more complex variety can be given to click sensation. As a result, more various operation sensations can be generated in accordance with input operation.

Although, in the click mechanism 10 of this embodiment, the width of the third protrusion 26 is made small compared to the width of the second protrusion 25, the opposed area of the first protrusion 24 and the third protrusion 26 can also be easily made smaller than the opposed area of the first protrusion 24 and the second protrusion 25 by making the thickness of the third protrusion 26 small compared to the thickness of the second protrusion 25. The magnetic attractive force F2 when the first protrusion 24 and the third protrusion 26 are directly opposed to each other can be thereby made smaller than the magnetic attractive force F1 when the first protrusion 24 and the second protrusion 25 are directly opposed to each other. As a result, various operation sensations can also be generated in accordance with input operation by making the thickness of the third protrusion 26 small compared to the thickness of the second protrusion 25.

Although, in the click mechanism 10 of this embodiment, the opposed area of the first protrusion 24 and the third protrusion 26 is made smaller than the opposed area of the first protrusion 24 and the second protrusion 25, the opposed spacing of the first protrusion 24 and the third protrusion 26 may be made larger than the opposed spacing of the first protrusion 24 and the second protrusion 25. The larger the opposed spacing of two opposed magnetic bodies, the smaller the magnetic attractive force generated between the two magnetic bodies. Therefore, also in this case, the magnetic attractive force F2 when the first protrusion 24 and the third protrusion 26 are directly opposed to each other can be made smaller than the magnetic attractive force F1 when the first protrusion 24 and the second protrusion 25 are directly opposed to each other. As a result, various operation sensations can be easily generated in accordance with input operation.

In the click mechanism 10 of this embodiment, when input operation is accompanied by rotation (including rocking and turning), the second magnetic body 22 can be rotated by utilizing the rotation of input operation, and the structure of the click mechanism 10 can be simplified. Therefore, the click mechanism 10 having this configuration is suitable for an input device in which input operation is accompanied by rotation, such as the input device 1.

In the click mechanism 10 of this embodiment, by disposing the third protrusion 26 adjacent to the second protrusion 25, the second protrusion 25 and the third protrusion 26 can be disposed in a balanced manner along the direction of rotation of the second magnetic body 22 (the direction of movement of the second magnetic body 22 relative to the first magnetic body 21). By disposing the second protrusion 25 and the third protrusion 26 in a balanced manner, compared to the case where a plurality of third protrusions 26 are all disposed at a position different from the position of the second protrusion 25, the ununiformity of magnetic attractive force in the direction of rotation of the second magnetic body 22 is reduced, and the rotation can be easily stabilized.

Since having such a click mechanism 10, the input device 1 of this embodiment can give variety to click sensation, and can generate various operation sensations in accordance with input operation.

Although the embodiment of the present invention has been described, the present invention is not limited to the above-described embodiment, and various changes may be made therein without departing from the spirit of the present invention.

In this embodiment, the click mechanism 10 has two click sensation generating portions 11 and each click sensation generating portion 11 has two first magnetic bodies 21. However, if sufficient click sensation can be generated with a single click sensation generating portion 11, the click mechanism 10 may have a single click sensation generating portion 11. If sufficient click sensation can be generated with a single first magnetic body 21, the click sensation generating portion 11 may have a single first magnetic body 21.

Although, in this embodiment, the magnet 23 is disposed on the first magnetic body 21 side and magnetizes the first magnetic body 21, a magnet may be disposed on the second magnetic body 22 side and may magnetize the second magnetic body 22. If the above-described magnetic path can be formed, a magnet may be disposed on each of the first magnetic body 21 side and the second magnetic body 22 side.

Although, in this embodiment, the first magnetic bodies 21 and the magnet 23 are stationary, and the second magnetic body 22 is rotated relative to the first magnetic bodies 21, the second magnetic body 22 may be stationary, and the first magnetic bodies 21 and the magnet 23 may be rotated relative to the second magnetic body 22.

In this embodiment, if a predetermined operation sensation is obtained, the number and shape of the first protrusions 24, the second protrusions 25, and the third protrusions 26 may be changed. In this embodiment, the second protrusions 25 and the third protrusions 26 are disposed so as to be adjacent to each other along the direction of rotation of the second magnetic body 22. However, if a predetermined operation sensation is obtained, and the rotation of the second magnetic body 22 is stable, the second protrusions 25 and the third protrusions 26 may not be disposed so as to be adjacent to each other.

In this embodiment, the input device in which the click mechanism 10 is mounted may be an input device such as a rotary encoder of an electronic device. The operation portion 40 may rotate one revolution or more together with the turning portion 16 of the driving portion 15 in accordance with input operation from the operator. The direction of rotation of the operation portion 40 may be clockwise or counterclockwise.

In this embodiment, the input device in which the click mechanism 10 is mounted may be a slide switch or the like. The second magnetic body 22 and the first magnetic body 21 may be rod-like members extending parallel to each other, and the first magnetic body 21 may be slid along the direction in which the second magnetic body 22 extends.

What is claimed is:

1. A click mechanism comprising:
a first magnetic body having a first protrusion;
a second magnetic body having a second protrusion; and
a magnet configured to magnetize at least one of the first magnetic body and the second magnetic body,
the click mechanism configured to, in accordance with input operation, move at least one of the first magnetic body and the second magnetic body relative to the other, and generate click sensation corresponding to the input operation using magnetic attractive force generated between the first protrusion and the second protrusion,
wherein the second magnetic body has a third protrusion configured to generate magnetic attractive force between itself and the first protrusion and differing in shape from the second protrusion.

2. The click mechanism according to claim 1, wherein the second protrusion and the third protrusion are disposed opposed to the first protrusion with a clearance therebetween, and the second protrusion and the third protrusion are configured such that magnitude of magnetic attractive force between the first protrusion and the third protrusion when the first protrusion and the third protrusion are directly opposed to each other is smaller than magnitude of magnetic attractive force between the first protrusion and the second protrusion when the first protrusion and the second protrusion are directly opposed to each other.

3. The click mechanism according to claim 2, wherein the second protrusion and the third protrusion are configured such that opposed area of the first protrusion and the third protrusion when the first protrusion and the third protrusion are directly opposed to each other is smaller than opposed area of the first protrusion and the second protrusion when the first protrusion and the second protrusion are directly opposed to each other.

4. The click mechanism according to claim 3, wherein the second protrusion and the third protrusion are formed such that width or thickness of the third protrusion is small compared to width or thickness of the second protrusion.

5. The click mechanism according to claim 2, wherein the second protrusion and the third protrusion are configured such that opposed spacing of the first protrusion and the third protrusion when the first protrusion and the third protrusion are directly opposed to each other is larger than opposed spacing of the first protrusion and the second protrusion when the first protrusion and the second protrusion are directly opposed to each other.

6. The click mechanism according to claim 1, wherein one of the first magnetic body and the second magnetic body is rotationally moved relative to the other.

7. The click mechanism according to claim 6, wherein the third protrusion is disposed along direction of movement of the second magnetic body relative to the first magnetic body so as to be adjacent to the second protrusion.

8. An input device comprising:
a case member;
an operation mechanism; and
a click mechanism comprising:
a first magnetic body having a first protrusion;
a second magnetic body having a second protrusion; and
a magnet configured to magnetize at least one of the first magnetic body and the second magnetic body,
the click mechanism configured to, in accordance with input operation, move at least one of the first magnetic body and the second magnetic body relative to the other, and generate click sensation corresponding to the input operation using magnetic attractive force generated between the first protrusion and the second protrusion,
wherein the second magnetic body has a third protrusion configured to generate magnetic attractive force between itself and the first protrusion and differing in shape from the second protrusion.
